(19) United States
(12) Patent Application Publication
(10) Pub. No.: US 2025/0258192 A1
(43) Pub. Date: Aug. 14, 2025

(54) Measuring equipment comprising a heating device

(71) Applicant: THALES, Meudon (FR)

(72) Inventors: Gaétan HUGUET, THONON LES BAINS (FR); Frédéric MARTIN, VENDOME CEDEX (FR); Mickaël RAHON, VENDOME CEDEX (FR); Virgile CHAUSSON, VENDOME CEDEX (FR)

(21) Appl. No.: 18/851,169

(22) PCT Filed: Mar. 29, 2023
(86) PCT No.: PCT/EP2023/058164

§ 371 Date: Sep. 26, 2024

(30) Foreign Application Priority Data
Mar. 30, 2022 (FR) FR2202869

(51) Int. Cl. G01P 5/165; B64D 15/20

(52) U.S. Cl. CPC G01P 5/165; B64D 15/20

(57) ABSTRACT

The invention relates to measuring equipment, comprising a heating device, and intended to be arranged externally, at the skin of a vehicle which can move in a hostile climate environment with icing climate conditions, said equipment corresponding to a body consisting of a mast supporting a tube closed at one of the ends thereof, the heating device being intended to be housed within said tube and comprising at least one heating wire coiled inside the body of said tube, according to a bridged coiling defined by the presence of a bridge (P), the bridge corresponding to a portion of heating wire overlapping, along the axis of said tube, a predetermined number of turns of the end of said coiling located near the open end (12) of said tube, the overlapping turns being evenly spaced at a predetermined pitch associated with the overlapping zone.

### CROSS-REFERENCE TO RELATED APPLICATIONS

This application is a U.S. non-provisional national phase entry under 35 USC § 371 of International Application PCT/EP2023/058164, filed Mar. 29, 2023, claiming the benefit of French Application No. 22 02869, filed on Mar. 30, 2022, all of said applications incorporated herein by reference in their entirety.

### FIELD

The present invention relates to measuring equipment comprising a heating device, said measuring equipment being intended to be arranged outside and at the skin of a vehicle apt to move in a hostile climate environment associated with icing climate conditions, said equipment corresponding to a body formed of a mat carrying a tube closed at one of the ends thereof, the heating device being intended to be housed within said tube and comprising at least one heating wire wound inside the body of said tube

The invention further relates to an aircraft comprising such a measuring equipment.

### BACKGROUND

The invention relates to the field of heating of measuring equipment intended to be arranged at the skin of a vehicle apt to move in a hostile climate environment associated with icing climate conditions, and more particularly icing climate conditions supercooled water or icing climate conditions crystals.

Such equipment corresponds e.g. to civil or military aeronautical measuring equipment comprising flush parts or appendages emerging from the skin of the aircraft (i.e. located outside the aircraft). According to another example, such an equipment item is equipment for measuring on the ground for military, scientific or meteorological fields, in particular for measurements in a context of extreme polar cold.

The appendages or flush parts belong e.g. to probes making it possible in particular to measure different aerodynamic parameters of the air flow surrounding the aircraft, such as in particular the total pressure, the static pressure, the temperature, or the incidence of the air flow in the vicinity of the skin of the aircraft. The total pressure associated with the static pressure, serves to determine the local velocity of the airflow in the vicinity of the probe, and ultimately the airspeed of the aircraft carrying the probe, as well as the altitude.

Other probes serve e.g. to measure the local incidence of an air flow. The incidence probes may include movable appendages intended to orient themselves along the axis of the air flow surrounding the probe. The orientation of the probe serves to determine the incidence of the air flow.

Other incidence probes may be equipped with fixed appendages equipped with a plurality of pressure taps. The pressure difference measured between the pressure taps serves also to determine the incidence of the air flow surrounding the probe.

During high altitude flight, the aircraft may encounter icing conditions.

Specifically, icing can form at the skin and on the appendages of the aircraft. The appearance of icing is particularly problematic for aerodynamic probes the profiles of which can be modified by icing and the pressure tap orifices of which can be blocked. In other words, the presence of icing is apt to distort the measurement of the total pressure of the probe and possibly make same inoperative under certain climate conditions.

One solution to prevent icing formation is to warm the appendages. Currently, heating is in most cases carried out by means of one or more heating wires wound and embedded in the appendages, the heating taking place by the Joule effect. For example, to warm up a total pressure probe, it is necessary to dissipate several hundred watts.

More precisely, such type of probe is formed of a mast supporting a tube closed at one of the ends thereof and called a Pitot tube, or else such type of probe is a Pitot-static probe.

The heating of the probe takes place by means of one or more heating wires, forming a heating resistor, wound (i.e. shaped in the form of a coil) inside the body of the probe, i.e. both in the mast and in the Pitot tube 10, the Pitot tube being illustrated in FIG. 1. Such a Pitot tube 10 has an open end 12 enabling the total atmospheric pressure to be measured. Moreover, according to one embodiment, such a tube optionally has an inner tube 14 located inside the tube of the Totale 16. Between the two tubes 14 and 16, a space 18 is intended for the insertion of the heating wire.

To make the heating wire, an electrical conductor (i.e. core) including an alloy of iron and nickel coated with an electrical, but not thermal, mineral insulator such as alumina or magnesia is commonly used. The insulator is as such coated with a sheath of nickel, nickel chromium or Inconel enabling the wire to be brazed to the body of the probe. In other words, such a heating wire corresponds to a metallic sheathed coaxial wire, or as an alternative to a shielded spiral wire. The shaping of the heating wire, also referred to hereinafter as “coiling”, within the Pitot tube 10, with or without an internal tube 12, is complex and aims to provide a high density of heat regularly distributed along the wall of the tube 10 of very small size, compared to the possibilities of forming the wire), and especially as close as possible to the open end 12 thereof which is the most critical for anti-icing and de-icing, especially in supercooled water.

In other words, the way to shape (i.e. “wind”) the heating element, generally such as a coaxial heating wire sheathed with metal, in the tube 10 of the Pitot or static Pitot pressure probe affects the deicing capacities, in particular of deicing with supercooled water.

The current heating wire shaping solutions are illustrated by FIGS. 2 and 3, representative of a pinned coiling of the state of the art and of a back-and-forth coiling as disclosed in patent EP 3 173 797 B1, respectively.

FIG. 2 illustrates a pinned coiling based on the use of a pin 20 positioned along the radial axis of the inner tube 14 shown in FIG. 1, the inner tube 14 not being not shown in FIG. 2 to keep the figure simple. To form a pinned coiling, the heating wire is first bent halfway along to form a loop 22, the loop 22 then being attached to the pin 20. The “double wire” corresponding to the two branches of the loop 22 is then simply wound, according to a single thickness, over a predetermined length with a predetermined pitch on the inner tube 14 shown in FIG. 1 and a coiling template, the coiling (i.e. the winding) being carried out along a direction going from the front facing the open end 12 of the Pitot tube, to the rear of the probe.

However, pinned coiling is not optimal mainly because of the loop 22 which surrounds the pin 20, the diameter of the loop 22 forcing the second double-wire turn 24 of the coil of heating wire, to move back. Such offset generates empty spaces 26 between the turns of the heating wires, because of the initial forming loop 22, the surface area of the empty spaces 26 being too large in proportion to the surface area heated directly. The density of the heating wire is thus lower than on the rest of the coil, whereas it is precisely at the open end 12 of the probe that the most power should be supplied. Such technological limitation is now compensated for by ensuring that the complete coiling has enough power to transfer same forwards by thermal conduction, but the drawback is an overheating of the nose of the Pitot tube on the ground or in non-icing conditions. Moreover, such voids 26 are potentially conducive to corrosion because same can become filled with pollution coming from the environment of the vehicle on which the measuring equipment comprising said tube 10 is arranged.

As an alternative, FIG. 3 represents another solution of the prior art corresponding to round-trip coiling as disclosed in patent EP 3 173 797 B1. Such a back-and-forth coiling consists in coiling the heating wire in a single-wire form (and not in a double-wire form as for the pinned coiling previously described with reference to FIG. 2) on a template, then the inner tube 14 (not shown in FIG. 3 for keeping the figure simple) in a first “outgoing” direction from the back to the front 12 of the probe. Then, once the open end 12 is reached, the coiling is continued in the same direction of rotation but is wound over the initial coiling (i.e. coaxially) along a second “return” direction from the front 12 to the rear of the probe, opposite the direction (i.e. reverse direction) of the first “outgoing” direction from the back to the front 12 of the probe.

In other words, such a “back-and-forth” coiling necessarily results in a superposition of two layers 28 and 30 (thicknesses) of coiling, as illustrated in section below the broken line of FIG. 3, which reduces the efficiency of the heating wire in transmitting heat by conduction. Indeed, between the two thicknesses of wire, a central zone of heat accumulation is formed, because the wire is not in direct contact with the zones of heat exchange, so that such a coiling can disadvantageously lead, under predetermined conditions, to a rise in temperature higher than or very close to the melting point of the solder which keeps the wire assembled on the body of the probe, and hence potentially a decrease in the service life of the probe.

In the non-contiguous part of the double coiling (i.e. according to two superposed layers), the two thicknesses 28 and 30 do not overlap over the entire surface. Nevertheless, it is difficult to ensure that the inner coiling 30, which is smaller in diameter, is well pressed against the walls and dissipates heat well. Thereby, such solution, although locally effective at the open end 12 of the tube 10, is not very effective in terms of overall efficiency and also leads to an increased risk of overheating on the ground.

In summary, such a “back-and-forth” coiling shown in FIG. 3 proposes to reduce the empty spaces 26 of the pinned coiling, by a “double coiling” corresponding to a coaxial superposition of the wound wire and thereby creating an “overdensity” of heat that can be detrimental to the service life of the heating wire, and what is more, not allowing the power necessary for deicing to be optimized, by creating zones without direct heat exchange with the zones to be heated.

Another solution of the prior art (not shown), consists in using a part of a non-self-regulating bi-material heating wire on the first turns of the coiling at the nose of the Pitot tube, to avoid losing local heating capacity when the conditions at the nose are severe, since the resistance of the wire decreases with temperature in more conventional structures. However, the use of a bi-material heating wire is expensive and presents risks in terms of reliability, in particular because of a potential breakage of the wire at the junction of the two materials forming same.

### SUMMARY

The goal of the present invention is thus to overcome the drawbacks of the aforementioned prior art, by proposing a new solution for shaping a heating wire (i.e. a new type of coiling) in order to integrate an optimal length of wire into the small space provided by the tube 10, by seeking to position the highest density of heating wire toward the front of the measuring equipment, i.e. near the open end 12 of the tube, to ensure maximum heat is provided to the nose of the measuring equipment, the nose being the part most exposed to hostile outdoor climate conditions, such as icing climate conditions supercooled water or freezing climate conditions crystals.

To this end, the invention relates to measuring equipment comprising a heating device, said measuring equipment being intended to be arranged outside and at the skin of a vehicle which can move in a hostile climate environment associated with icing climate conditions, said equipment corresponding to a body consisting of a mast supporting a tube closed at one of the ends thereof, the heating device being intended to be housed within said tube and comprising at least one heating wire coiled inside the body of said tube, the coiling of said heating wire being a bridged back-and-forth coiling defined by the presence of a bridge, the bridge corresponding to a portion of heating wire overlapping, along the axis of said tube, a predetermined number of turns of the end of said coiling located near the open end of said tube, the overlapping turns being evenly spaced at a predetermined pitch associated with the overlapping zone.

Such a “bridged coil” proposed according to the present invention serves to increase the heating density at the front open end of the tube, which is the critical zone for the anti-icing or deicing of the probe under icing conditions supercooled water, but also on a smaller scale under icing conditions crystals.

In other words, the principle of the present invention thus consists in eliminating the pin and the initial forming loop of the pinned coiling in order to be able to arrange the coiling turns evenly spaced apart, while carrying out the return path of the wire parallel to the axis of revolution of the coiling and in a zone of heat exchange with the zones to be heated in order to limit superpositions and hence heat losses.

The bridge of the bridged coiling according to the present invention serves to obtain a “back-and-forth” coiling almost in a single thickness and not in a double thickness according to the aforementioned state of the art relating to the back-and-forth coiling as disclosed in patent EP 3 173 797 B1. In fact, the only zone of double thickness according to the present invention is limited to the overlapping zone and has a surface area limited to the contact surface between the wire of the bridge and the turns that the bridge overlaps (i.e. straddles), so that the heat generation associated with the reduced contact surface is negligible in terms of heat loss.

According to other advantageous aspects of the invention, the measuring equipment comprises one or a plurality of the following features, taken individually or according to all technically possible combinations:
according to a first configuration, said bridge is external, being located on the overlapped turns along a radial direction going from the inside to the outside of said tube;
according to a second configuration, said bridge is internal, being located under the overlapped turns, along a radial direction going from the inside to the outside of said tube;
each turn forming the coiling is wound along the same direction with a winding diameter substantially equal from one turn to another;
said predetermined number of turns and/or the spacing pitch of said turns is predetermined as a function of the heat density needed to deice the open end of said tube, and according to a predetermined mission of the vehicle;
said turns overlapped by said bridge are contiguous;
said equipment has within said tube a groove configured to house said bridge;
said measuring equipment is a Pitot probe or a Pitot-static probe, said tube corresponding to a Pitot tube, said groove being provided at the tube of the Totale of said Pitot tube to house an external bridge according to said first configuration;
said measuring equipment is a Pitot probe or a Pitot-static probe, said tube corresponding to a Pitot tube, said Pitot tube further comprising an inner tube, said groove being formed at said inner tube of said Pitot tube to house an inner bridge according to said second configuration.

The present description further relates to an aircraft comprising a measuring equipment comprising a heating device such as described hereinabove.

### BRIEF DESCRIPTION OF THE DRAWINGS

Such features and advantages of the invention will become clearer upon reading the following description, given only as a non-limiting example, and made with reference to the enclosed drawings, wherein:

FIG. 1 is a schematic sectional view of measuring equipment according to the present invention corresponding to a Pitot pressure probe;

FIGS. 2 and 3 illustrate the solutions of the prior art described hereinabove for heating the measuring equipment of FIG. 1, and not described again hereafter;

FIG. 4 is a schematic representation of two embodiments of the bridged coiling according to the invention.

### DETAILED DESCRIPTION

Hereinafter in the description, the expression “substantially equal to” refers to a relation of equality within plus or minus 10%, preferably within plus or minus 5%.

Hereinafter, the term “turn” refers to each of the turns of the heating wire from which the coiling according to the present invention is formed.

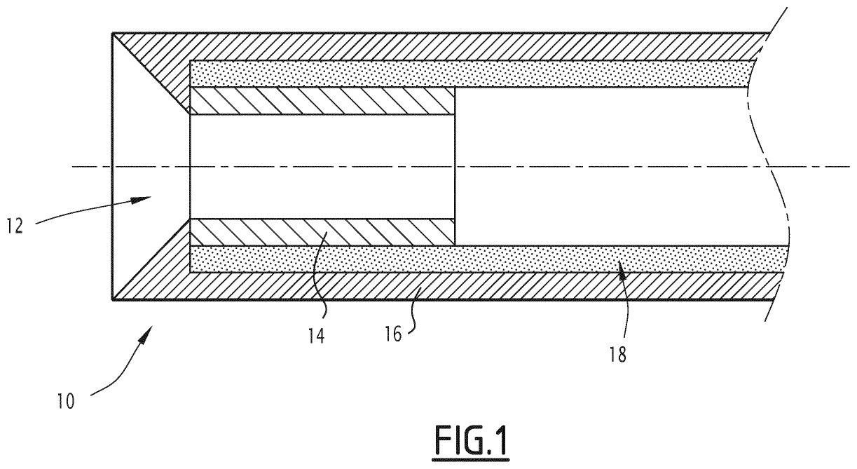

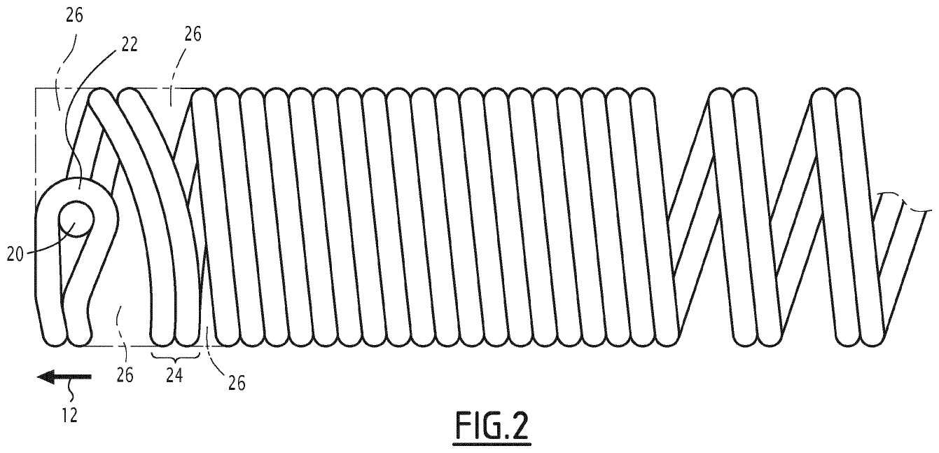

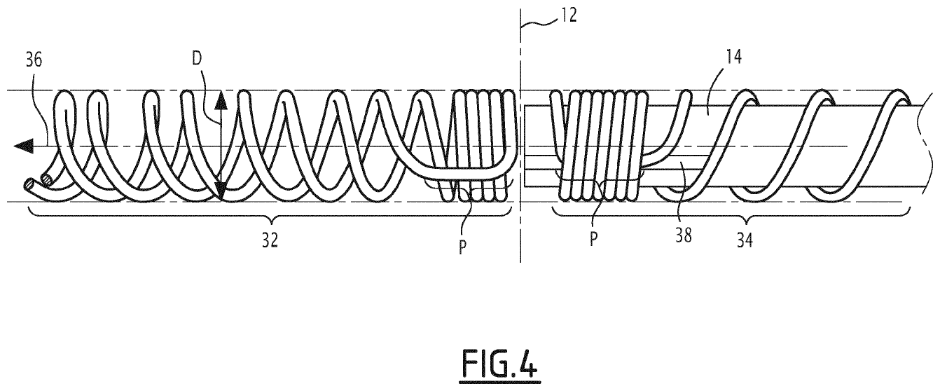

FIG. 4 is a schematic view of two embodiments 32 and 34 of a bridged coiling of a heating device of measuring equipment, proposed according to the present invention, and intended to be arranged outside and at the skin of a vehicle apt to move in a hostile climate environment associated with icing climate conditions, the equipment corresponding to a body formed of a mast supporting a tube 10, as illustrated in FIG. 1 described hereinabove, said tube 10 being closed at one of the ends thereof.

The heating device is intended to be housed within said tube 10 and comprises at least one heating wire wound in the body of said tube 10.

More precisely, for the two embodiments (i.e. configurations) 32 and 34, the coiling of said heating wire is a bridged back-and-forth coiling defined by the presence of a bridge P, the bridge P corresponding to a portion of heating wire overlapping, along the axis 36 of said tube, a predetermined number of turns of the end of said coiling located near the open end 12 of said tube 10, said overlapped turns being regularly spaced at a predetermined pitch associated with the overlap zone.

It should also be noted that each end of the bridge is used to form a turn.

According to an additional optional aspect, the predetermined number of overlapped turns is strictly less than the total number of turns minus one. According to another additional optional aspect, advantageously in terms of thermal congestion since limiting the hot points and maximizing the contact zones between the heating wire and the tube 10, for the two embodiments (i.e. configurations) 32 and 34, each turn forming the coiling is wound in the same direction (i.e. preferentially from the front 12 to the rear or alternatively from the rear to the front 12) with a coiling diameter D substantially equal from one turn to the other.

In addition, the predetermined number of turns and/or the spacing pitch of said turns, e.g. four turns for the first configuration 32 and seven turns for the second configuration 34, is predetermined as a function of the heat density needed to deice the open end 12 of said tube 10, and according to a predetermined mission of the vehicle, in particular taking into account e.g. the geographical area of the mission and the associated climate, and also the type of measuring equipment considered. According to another example, said overlapping turns are contiguous on the first centimeter of coiling close to the open end 12, and there are ten contiguous turns.

The predetermined number of turns and/or the spacing pitch of said turns is obtained, in particular, by means of thermal calculations as a function of the heating density (i.e. heat) required near the open end 12 and for the measurement mission in question, to prevent any measurement from being distorted by icing.

According to a variant of embodiment, the spacing pitch is such that the said turns overlapped by said bridge are contiguous, which serve to maximize the heating density close to the open end 12 of the tube 10, the most critical zone to be deiced, in particular to prevent icing from distorting the measurement made by means of said measuring equipment. For example, said overlapped turns are contiguous over the first centimeter of coiling close to the open end 12.

According to a first configuration 32, said bridge P is external, being located on the turns, contiguous in the example shown in FIG. 4, along a radial direction going from the inside to the outside of said tube 10 (i.e. the term “external” being understood along said radial direction going from the inside to the outside of said tube 10).

To obtain such a shaping of the first configuration 32 illustrated in FIG. 4, the associated shaping method comprises a first step of forming the contiguous part of the turns of heating wire, then a second step of forming the external point P above said contiguous turns, then a third step of shaping the non-contiguous part of the heating wire.

According to an optional additional variant, when, as illustrated in FIG. 1, the measuring equipment is a Pitot probe or a Pitot-static probe, such equipment has a groove configured within the tube 10 to house said bridge P. It should be noted that in FIG. 4, for reasons of representation, the groove suitable for housing the outer bridge of the first configuration 32 is not shown, whereas the groove would be formed in the tube of the Totale 16 shown in FIG. 1 to house the outer bridge P according to said first configuration 32.

According to a second configuration 34, said bridge P is internal, being located under the turns, contiguous in the example of FIG. 4, along a radial direction going from the inside to the outside of said tube 10 (i.e. the term “internal” being understood along said radial direction going from the inside to the outside of said tube 10).

According to an additional optional variant, when, as illustrated by FIG. 1, the measuring equipment is a Pitot probe or a Pitot-static probe, said tube 10 corresponding to a Pitot tube, said Pitot tube further comprising an inner tube 14 as illustrated in FIGS. 1 and 4, such equipment having, within the tube 10 and at said inner tube 14, a groove 38 configured to house said bridge P. To obtain such a shaping of the second configuration 34 illustrated in FIG. 4, the associated shaping method comprises a first step of preforming the internal bridge P, a second step of inserting said internal bridge P into said dedicated groove 38 of the internal tube 14, then a third step of forming the contiguous part of the turns of heating wire, as illustrated according to the example shown in FIG. 4, then a fourth step of forming the non-contiguous part of the turns of heating wire.

Independently of the configuration 32 or 34, the bridged coiling comprises, according to the embodiment illustrated in FIG. 4, both a non-contiguous part and a contiguous part overlapped by said bridge.

Independently of the configuration 32 or 34, according to an aspect not shown, such assemblies are held in position by strong brazing, all the cavities and intersections of the part being filled with brazing.

It should be noted that such bridged coiling heating assemblies take advantage in particular of the change of the parts neighboring the coiling. Indeed, in the latest designs of probes, such parts, namely the inner tubes 14 and tubes of the Totale 16, tend to be thicker and thicker, and the present invention takes advantage of such excess thickness of material to accommodate other functions, such as the bridged coiling proposed herein, the housing grooves optionally proposed in addition to housing the coiling bridge P being suitable for being integrated (i.e. housed) within such an excess thickness of the inner tube 14 for the configuration 34 of bridged coiling with an inner bridge, and the tube of the Totale 16 for the 32 configuration of bridged coiling with external bridge.

Such bridge makes it possible, independently of the configuration 32 or 34, to obtain a “back-and-forth” coiling almost in a “single thickness” of heating wire.

The very fine surface of “double thickness” can certainly generate a heat loss, but which is negligible, especially considering the fact that embedding the bridge P in a groove 38 of the inner tube 14 or of the tube of the Totale 16 (i.e. outer tube 16) serves to recover the calories of such portion of heating wire bridge for heating zones to be deiced.

It should be noted that the coiling at the end may or may not have a contiguous turn, depending on the heat density required in said zone.

A person skilled in the art would understand that the invention is not limited to the embodiments described, nor to the particular examples of the description, the above-mentioned embodiments and variants being suitable for being combined with one another so as to generate new embodiments of the invention.

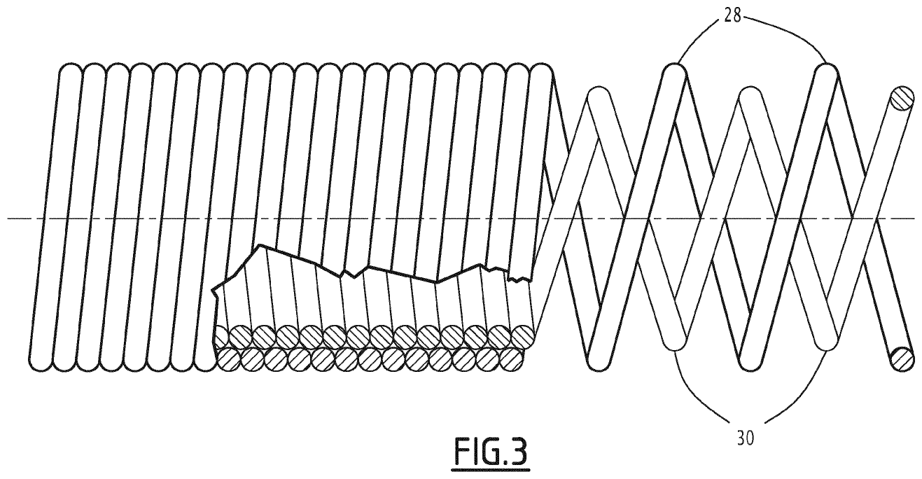

Thereby, the present invention, by means of the bridged coiling proposed, and illustrated by FIG. 4, makes it possible to retain all the advantages of the “back-and-forth” coiling of the state of the art illustrated previously by FIG. 3, avoiding the congestion and loss of efficiency associated with the implementation of a double thickness throughout the “back-and-forth” of the coiling. In other words, the present invention makes it possible to overcome the double thickness which takes up more space and which leads to difficulties in dissipating heat.

More precisely, the bridged coiling proposed according to the present invention makes it possible to bring the greatest possible density of heating wire to the front of the measuring equipment, without the empty spaces associated according to the prior art, with a pinned coiling.

The present invention makes it possible to significantly improve the deicing performance of Pitot or Pitot-static probes in supercooled water, in particular in the most critical zone: the front end of such Pitot or Pitot-static probes, without however affecting the service life of the wire by overheating in less severe conditions, in particular on the ground or in case of high altitude dry air flight.

1. A measuring equipment item comprising a heating device, said measuring equipment being intended to be arranged outside and at the skin of a vehicle apt to move in a hostile climatic environment associated with icing climatic conditions, said equipment corresponding to a body formed of a mast carrying a tube closed at one of the ends thereof, the heating device being intended to be housed within said tube and comprising at least one heating wire wound inside the body of said tube,
wherein the coiling of said heating wire is a bridged back-and-forth coiling defined by the presence of a bridge, the bridge corresponding to a portion of heating wire overlapping, along the axis of said tube, a predetermined number of turns of the end of said coiling located proximate to the open end of said tube, said overlapped turns being evenly spaced at a predetermined pitch associated with the overlap zone.

2. The measuring equipment according to claim 1, wherein, in a first configuration, said bridge is external, being located on the overlapped turns along a radial direction from the inside to the outside of said tube.

3. The measuring equipment according to claim 1, wherein, according to a second configuration, said bridge is internal, being located under the overlapped turns, along a radial direction going from the inside to the outside of said tube.

4. The measuring equipment according to claim 1, wherein each turn forming the coiling is wound in the same direction with a coiling diameter substantially equal from one turn to the other.

5. The measuring equipment according to claim 1, wherein said predetermined number of turns and/or spacing pitch of said turns is predetermined as a function of the heat density needed to deice the open end of said tube, and according to a predetermined mission of the vehicle.

6. The measuring equipment according to claim 5, wherein said turns overlapped by said bridge are contiguous.

7. The measuring equipment according to claim 1, wherein said equipment has a groove within said tube configured to receive said bridge.

8. The measuring equipment according to claim 2, wherein said measuring equipment is a Pitot probe or a Pitot-static probe, said tube corresponding to a Pitot tube, and wherein said equipment has a groove within said tube configured to receive said bridge, said groove being formed at the tube of the tube of the Totale of said Pitot tube to house an external bridge according to said first configuration.

9. The measuring equipment according to claim 3, wherein said measuring equipment is a Pitot probe or a Pitot-static probe, said tube corresponding to a Pitot tube, said Pitot tube further comprising an inner tube, and wherein said equipment has a groove within said tube configured to receive said bridge, said groove being provided at said inner tube of said Pitot tube to house an inner bridge according to said second configuration.

10. An aircraft comprising a measuring equipment comprising a heating device according to claim 1.
